(19) United States
(12) Patent Application Publication
(10) Pub. No.: US 2023/0130612 A1
(43) Pub. Date: Apr. 27, 2023

(54) SAW TOOTH FOR FORESTRY HARVESTER

(71) Applicant: U.S. Tsubaki Holdings, Inc., Wheeling, IL (US)

(72) Inventor: Derek Imig, Blaine, MN (US)

(21) Appl. No.: 17/954,688

(22) Filed: Sep. 28, 2022

Related U.S. Application Data
(60) Provisional application No. 63/270,353, filed on Oct. 21, 2021.

(51) Int. Cl. B27B 33/12; A01G 23/091

(52) U.S. Cl. CPC B27B 33/12; A01G 23/091

(57) ABSTRACT

A saw tooth includes a body, a plurality of petals, and a plurality of inserts. The body has a forward surface defining a perimeter, a rearward surface, and, a plurality of sides extending between the forward and rearward surfaces. Each petal has a forward surface and a rearward surface, and the rearward surface defines a perimeter. The petal is coupled to the forward surface of the body. The perimeter of the rearward surface of the petal does not extend outwardly beyond the perimeter of the forward surface of the body. Each insert is positioned between two of the petals, is coupled to the body, and has an outer side. The outer side of the insert extends outwardly beyond a corresponding side of the body.

### CROSS REFERENCE TO RELATED APPLICATIONS

This application claims the benefit of U.S. Prov. No. 63/270,353, filed on Oct. 21, 2021, the entirety of which is incorporated by reference herein.

### BACKGROUND

This disclosure relates to saws (and in particular, saw teeth) used in the field of forestry. Such saw teeth can be part of a saw on a feller-buncher harvester, for example. The techniques disclosed herein are not limited to any particular type of saw.

### SUMMARY

According to embodiments, a saw tooth includes a body, a plurality of petals (e.g., four petals), and a plurality of inserts (e.g., four inserts). The body includes (or is composed of) a first material. The body has a forward surface defining a perimeter, a rearward surface, a plurality of sides (e.g., four sides) extending between the forward and rearward surfaces, and a plurality of corners located between the sides.

For each of the petals, the petal includes (or is composed of) a second material. The second material (such as a carbide material) may be harder than the first material (such as steel). The petal has a forward surface and a rearward surface, wherein the rearward surface defines a perimeter. The thickness of the petal between the forward surface and the rearward surface may vary. The petal is coupled to the forward surface of the body. The perimeter of the rearward surface of the petal does not extend outwardly beyond the perimeter of the forward surface of the body. The petal includes a corner that corresponds to one of the corners of the body. The thickness between the forward surface and the rearward surface of the petal may be greatest at the corner of the petal. The corner of the petal and each of the corners of the body may be chamfered.

For each of the inserts, the insert includes (or is composed of) the second material. The insert has an outer side. The insert is positioned between two of the petals. The insert is coupled to the body. The outer side extends outwardly beyond a corresponding side of the body. The insert has a forward surface with a left portion and a right portion. The left portion may be coplanar with the forward surface of one of the petals, and the right portion may be coplanar with the forward surface of another of the petals.

For each of the inserts, a first joint is located between the insert and one of the petals, and a second joint is located between the insert and a different one of the petals. Each of these joints define a respective forward extent and sideward extent, and the forward extent of the first joint and the forward extent of the second joint may converge as the forward extents approach an outer perimeter of the forward surface of the saw tooth. Additionally (or separately), the sideward extent of the first joint and the sideward extent of the second joint may diverge as the joints extend downwardly from the outer perimeter of the forward surface of the saw tooth. A third joint is located between the insert and the body. Two segments of the third joint may be parallel to each other. Some, all, and/or a portion of the three joints may include (or be composed of) a third material, such as a material used for brazing. Some, all, and/or a portion of the three joints may not have any material.

For each of the inserts, the insert may be configured to cause a flow of debris across a forward surface of the saw tooth to divide into plurality of lesser flows of debris (e.g., two lesser flows). At least two of the lesser flows of debris may flow in diverging directions across a side of the saw tooth.

### BRIEF DESCRIPTION OF SEVERAL VIEWS OF THE DRAWINGS

FIG. 1A is a perspective view of a prior art saw tooth.

FIG. 1B is a perspective view of a saw that includes prior art saw teeth, where the saw teeth engage with a tree trunk.

FIG. 1C illustrates deterioration of the saw teeth of FIG. 1B, after the saw has been in use for a period of time.

FIG. 2A is a top plan view of a portion of the saw shown in FIG. 1B.

FIG. 2B is a perspective view of a portion of the saw shown in FIG. 1B, where the saw tooth is shown as moving through the tree trunk towards the viewer.

FIG. 3A is a perspective view of a saw tooth, according to embodiments disclosed herein.

FIG. 3B is elevation view of the saw tooth of FIG. 3A in an orientation in which the saw tooth is mounted to a saw, according to embodiments disclosed herein.

FIG. 3C is a top plan view of the saw tooth of FIG. 3A, according to embodiments disclosed herein.

FIG. 4A shows a top plan view of the saw tooth of FIG. 3A, and further depicts representations of debris flows across the tooth generated by the cutting process.

FIG. 4B shows an elevation view of the saw tooth of FIG. 3A, and further depicts representations of debris flows across the tooth generated by the cutting process.

FIG. 5 is a perspective view of a saw tooth with an integrated shaft, according to embodiments disclosed herein.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

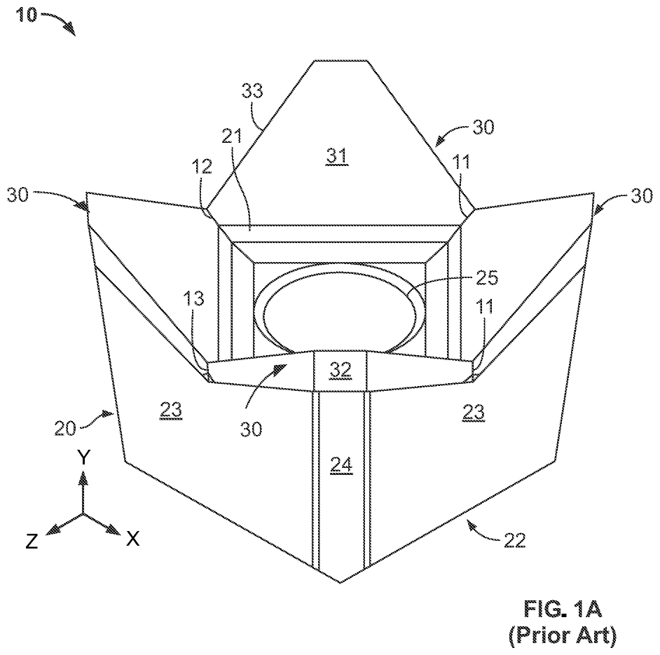

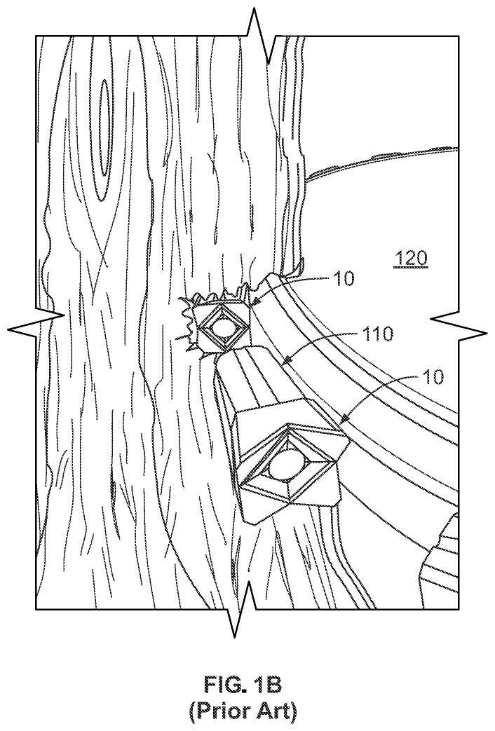

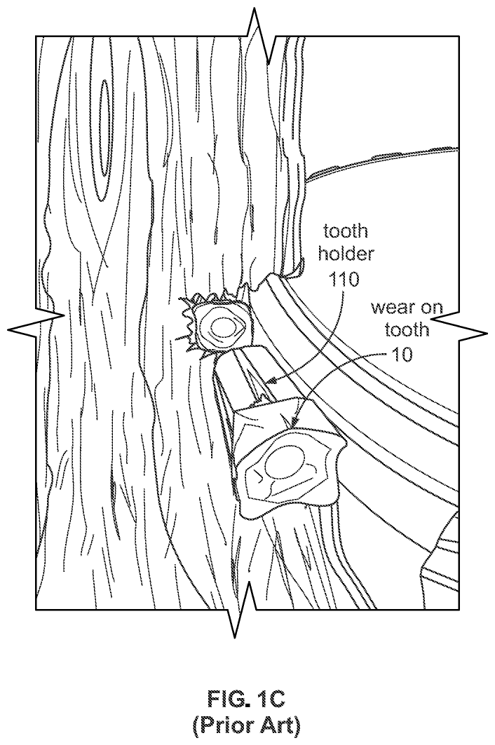

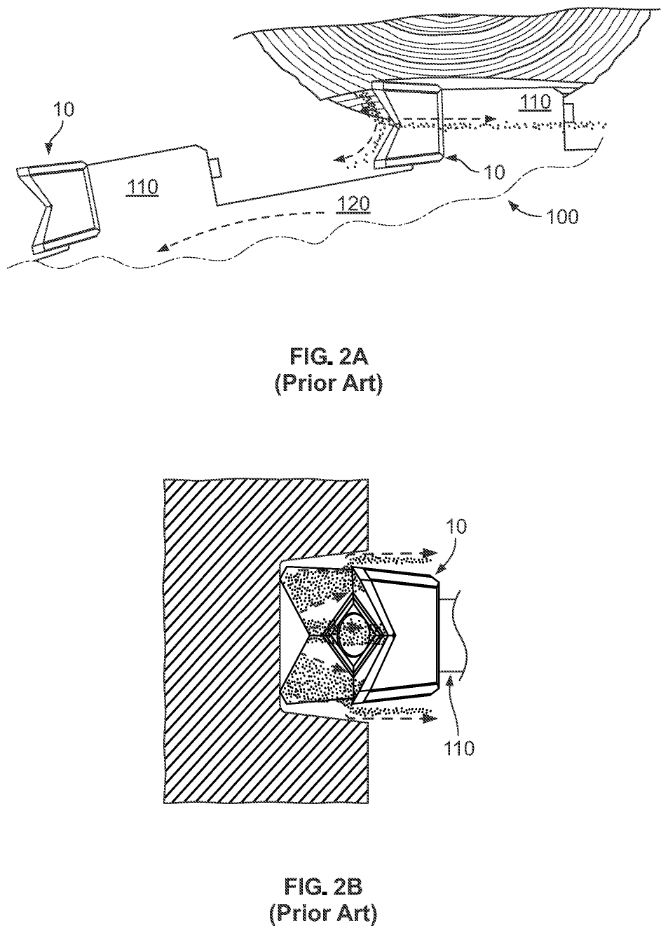

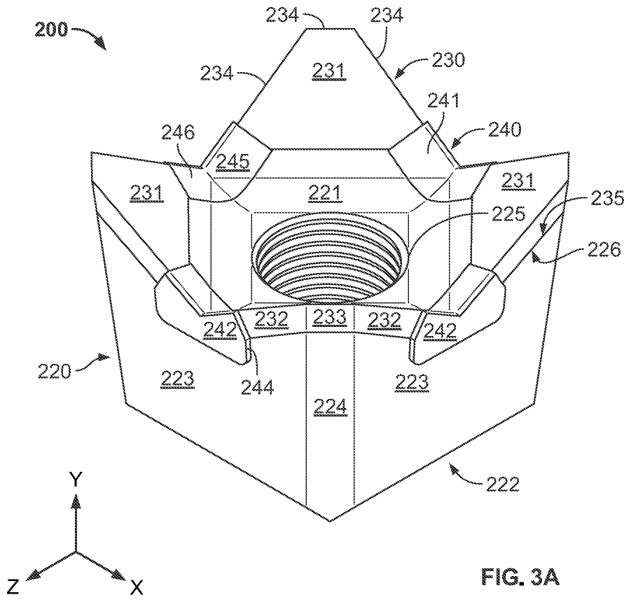

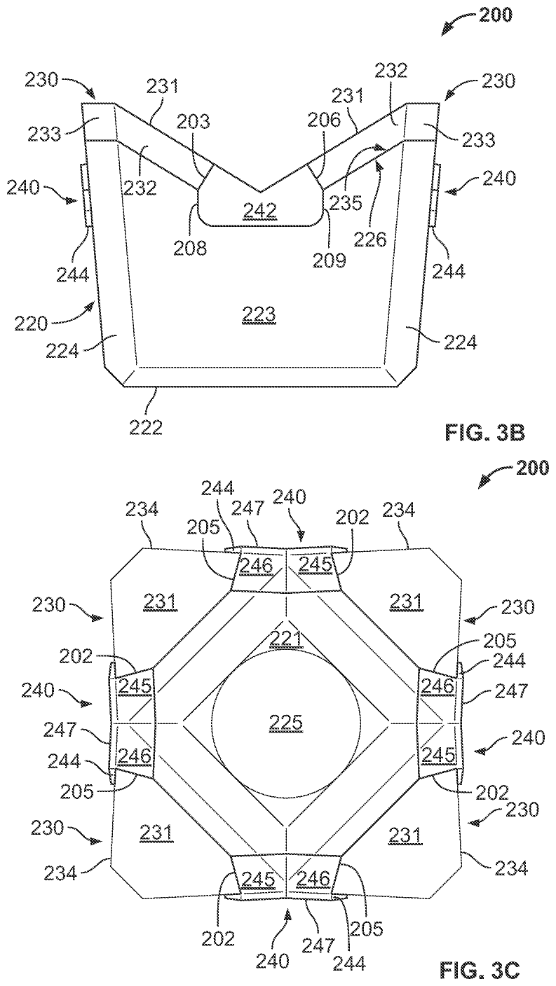

FIG. 1A is a perspective view of a prior art saw tooth 10, or more simply “tooth.” For the sake of defining a frame of reference, the tooth 10 is described herein with reference to Cartesian coordinate system as shown in FIG. 1A. The height of the tooth 10 extends along the y-axis. The width of the tooth 10 extends along the x-axis, and the depth of the tooth 10 extends along the z-axis. The width and depth dimensions are defined between respective lateral sides of the tooth 10 as shown in FIG. 1A (i.e., the width and depth of the tooth 10 are not defined between corners of the tooth 10). The same frame of reference is used to describe tooth 200, as shown in FIG. 3A. To be clear, the tooth 10 is shown in a different orientation in FIG. 1A than in FIGS. 1B, 1C, 2A, and 2D. In the latter group of figures, the tooth 10 is essentially rotated ninety degrees from its orientation in FIG. 1A. Still, the tooth 10 will be referenced with respect to the Cartesian coordinate system as oriented in FIG. 1A.

The tooth 10 has a body 20 and four petals 30. The body 20 may be made of steel. The body 20 has a forward surface 21 and a rearward surface 22. The words “forward” and “rearward” as used herein refer to the direction in which the tooth 10 moves during operation of the saw, which is illustrated in FIGS. 1B, 1C, 2A, and 2D. Turning back to FIG. 1A, much of the forward surface 21 is obscured by the petals 30, as the forward surface 21 extends underneath the petals 30. The rearward surface 22 is not visible in FIG. 1A, but its position is still indicated. The body 20 may have four sides 23 extending between the forward surface 21 and rearward surface 22. The body 20 may have four chamfered corners 24, each of which may be located between two of the sides 23. The width of the body 20 may vary such that it is widest at the forward surface 21 and narrowest at the rearward surface 22. Thus, the sides 23 and the chamfered corners 24 may taper inwardly (or outwardly, depending on the perspective). The body 20 may have a hole 25, which may extend between the forward surface 21 and rearward surface 22. The hole 25 may be designed to receive a bolt, thereby mounting the tooth 10 to a tooth holder (which is indicated by reference numeral 110 in FIGS. 1B, 1C, 2A, and 2B). The hole 25 may include threads, which match those of the mounting bolt.

The petals 30 may be attached (e.g., brazed) to the forward surface 21 of the body 20. The petals 30 may be made of tungsten carbide, which may be harder than the body 20 (e.g., steel). Each petal 30 may have a forward surface 31 and a corner 32. A cutting edge 33 with three sides may be located on the forward surface 31. A joint 11 may be formed where two petals 30 meet. As used herein, a “joint” can be, but need not be filled with material partially or entirely. A joint refers to a boundary between two different parts, regardless of whether the boundary has a thickness or whether the boundary includes a material. The tooth 10 may have four joints 11 between the petals 30, in all. Each joint 11 may have a forward extent 12 (the part of the joint 11 exposed to the forward surface of the tooth 10) and a sideward extent 13 (the part of the joint 11 exposed to a side of the tooth 10). The forward extent 12 of each joint 11 may not be angled along the x-axis or z-axis. That is, two of the forward extents 12 may extend along the x-axis and the other two forward extents 12 extend along the z-axis. The forward extents 12 may be each angled along the y-axis. Additionally, for each joint 11, the sideward extent 13 may not be angled along the y-axis.

As further shown in FIG. 1A, the elevation of the perimeter of the forward surface of the tooth 10 may have four regions of maximum elevation (hereinafter, maximums) and four points of minimum elevation (hereinafter, minimums). The maximums may occur at the corners 32 of the forward surfaces 31 of the petals 30. The minimums may occur at where the joints 11 intersect the perimeter of the forward surface of the tooth 10.

FIG. 1B is a perspective view of a saw 100 including a plurality of prior art saw teeth 10 attached to a tooth holders 110 and rotating disk 120. A tree trunk is also depicted for reference. Each tooth 10 may be bolted to a tooth holder 110, which may be connected to the rotating disk 120. As shown, the disk 120 and tooth holders 110 may be integrated. The disk 120 is shown as rotating counterclockwise, such that each tooth 10 is pulled through the tree trunk towards the viewer.

FIG. 1C illustrates deterioration of the saw 100 shown in FIG. 1B, after the saw 100 has been in use for a period of time. As will be further described in more detail, when a tooth 10 cuts through wood, the wood separates into many pieces, thereby creating sawdust. The sawdust can mix with other particles, such as sand. Collectively, these particles are referred to herein as “debris.” As the saw 100 moves, the debris flows over the different components of the saw 100. Over time, the debris may cause wear on the tooth 10, tooth holder 110, and disk 120 along the paths where the debris flows.

The wear on the tooth 10 and tooth holder 110 is particularly relevant to the disclosure herein. As partially shown in FIG. 1C, the wear tends to be more prominent along two of the sides of the tooth 10—specifically the side facing upwardly (shown) and the side facing downwardly (not shown). While the perspective shown in FIG. 1C depicts wear on the former but not on the latter, similar wear patterns will occur on both of these surfaces of the tooth 10. Additionally, similar wear patterns may appear on the top surface of the tooth holder 110 (as shown) and the bottom surface of the tooth holder 110 (which is obscured due to the perspective of FIG. 1C). The debris flows may also cause wear on the disk 120, but that is not depicted in FIG. 1C.

FIG. 2A is a top plan view a portion of the saw 100 shown in FIG. 1B. FIG. 2B is a perspective view of a portion of the saw 100 shown in FIG. 1B, where the tooth 10 is shown as moving through the tree trunk towards the viewer. FIGS. 2A and 2B show different views of the same process. Some reference numerals are omitted from FIGS. 2A and 2B for the sake of clarity. The reference numerals pertaining to the parts of the tooth 10 are also shown in FIG. 1A.

As the disk 120 rotates and the tooth 10 is pulled through the tree trunk, flows of debris are generated. These are depicted as streams or flows of particles. Next to these flow depictions, broken lines with arrowheads illustrate the direction of the flows. The illustration of debris flows in the figures and corresponding description is not meant to be a precise portrayal of fluid and particle dynamics when the saw 100 cuts through a material such as wood. Instead, these debris flows are intended to illustrate general concepts, and they may lack a certain amount of precision.

As the tooth 10 is pulled through the tree trunk, cutting edges 33 of two petals 30 engage with the wood. This generates debris, which then flows across different regions of the outer surface of the tooth 10. Roughly speaking, there are three different flows, two of which are shown in FIG. 2A. All three are shown in FIG. 2B. Each of these flows may tend to be concentrated in regions proximate to three of the minimums on the perimeter of the forward surface of the tooth 10. A respective joint 11 may be present at each of these three minimums. The joints 11 may be effectively vulnerable areas in the tooth 10 where erosion can take root and spread. For example, the joints 11 may include filler metal used for brazing. The filler metal may be softer than the carbide petals 30 or the steel body 20, and therefore the debris flows may wear the filler metal more quickly. The debris flows can then penetrate into the joint 11, and erosion can accelerate. After traversing the forward surface of the tooth 10, some of the debris flows may travel along some sides of the tooth 10 and further across the tooth holder 110. These debris flows may cut into the petals 30, the tooth body 20, and/or the tooth holder 110.

As shown in FIG. 2B, there may be generally three main debris flows. The uppermost debris flow is the first debris flow. The middle debris flow is the second debris flow. The lowermost debris flow is the third debris flow. Each of these three debris flows as depicted extends from a location where the cutting edge 33 of the petals 30 engage with the wood. The first debris flow may continue over the forward surface of the tooth 10, then along the top-most side 23 of the tooth body 20, and further along the top surface of the tooth holder 110 (as better seen in FIG. 2A). The second debris flow may run along the forward surface of the tooth 10 in a direction towards the disk 120. The second debris flow, however, may not continue along a side 23 of the tooth body 20. Instead, after the second debris flow traverses the forward surface of the tooth 10, the second debris flow may project forwardly in the direction of rotation (as better depicted in FIG. 2A). The third debris flow may be similar to the first debris flow, except the third debris flow may proceed over the bottom-most side 23 of the body 20, and further along the bottom surface of the tooth holder 110 (not depicted). As depicted, all three flows may concentrate where three of the joints 11 are located (i.e. at three different minimums). The first debris flow and the third debris flow may tend to be the most significant flows that contribute to wear of the tooth 10 and tooth holder 110. The second debris flow may cause wear on the disk 120 (this wear is not depicted). There may not be a substantial debris flow along the side 23 of the body 20 most distal from the disk 120 (i.e., the side closest to the wood being cut).

FIG. 3A shows a perspective view of a tooth 200, according to embodiments disclosed herein. FIG. 3B is elevation view of the tooth 200 in an orientation in which the saw tooth may be mounted to a saw. FIG. 3C is a top plan view of the tooth 200. The tooth 200 may include a body 220, four petals 230, and four inserts 240. Reference numerals are not indicated for every feature on each component. As shown, the petals 230 may be substantially identical to each other, and the inserts 240 may be substantially identical to each other. For every identical component, the reference numerals will be the same. It may be possible for the tooth 200 to have more or fewer than four petals 230 and four inserts 240. The body 220 may include or may be made of steel. The body 220 may have a forward surface 221 and a rearward surface 222. Much of the forward surface 221 is obscured by the petals 230, as the forward surface 221 extends at least partially underneath the petals 230. The forward surface 221 has a perimeter 226. The rearward surface 222 is not visible in FIG. 3A, but its position is still indicated. The body 220 may have four sides 223 extending between the forward surface 221 and rearward surface 222, although the body may have more or fewer than four sides 223. The body 220 may have corners 224 (four as shown), each of which is located between two of the sides 223. The corners 224 may be chamfered as depicted. The width of the body 220 may vary such that it may be widest at the forward surface 221 and narrowest at the rearward surface 222. Thus, the sides 223 and the corners 224 may taper inwardly (or outwardly, depending on the perspective). The body 220 may have a hole 225, which may extend entirely or partially between the forward surface 221 and rearward surface 222. The hole 225 may receive a bolt, thereby mounting the tooth 200 to a tooth holder (such as tooth holder 110 shown in FIGS. 1B, 1C, 2A, and 2B). The hole 225 may include threads that match those of the mounting bolt.

The petals 230 may be made of or include tungsten carbide or another material. Such materials may be harder than the material of the body 220. Each petal 230 may have a forward surface 231, a rearward surface (not visible in the figures), a side 232, and a corner 233 (which forms a portion of the side 232). The thickness of the petal 230 between the forward surface 231 and the rearward surface may be constant (as shown), or may vary as generally shown in the petals of tooth 10. As one example, the thickness may be approximately 4.3 mm. In a different embodiment, the thickness may vary at a constant rate (i.e., flat converging/diverging surfaces) as shown in tooth 10. When the thickness of the petal 230 varies, the thickness may be greatest at the corner 233.

A cutting edge 234 may be located around the outer perimeter of the forward surface 231. The petal 230 may be coupled (e.g., brazed, soldered, or otherwise fixed in relation) to the body 220. For example, the rearward surface and/or side 232 of the petal 230 may be brazed (or otherwise coupled) to the forward surface 221 and/or at least one side 223 of the body 220. The rearward surface of the petal 230 has a perimeter 235. The perimeter 235 of the rearward surface may not extend outwardly beyond the perimeter 226 of the forward surface 221 of the body 220. The side 232 of the petal 230 may wrap around two different sides and a corner of the tooth 200. The side 232 of the petal 230 may be coplanar with two respective sides 223 of the body 220. The side 232 of the petal 230 may also be coplanar with a respective corner 224 of the body 220. In one embodiment, the side 232 of the petal 230 forms a continuous surface with two of the respective sides 223 and the respective corner 224 of the body 220. The joint between the petal 230 and the body 220 is understood to be part of this continuous surface. This continuous surface may be substantially flat and may taper inwardly as it extends downwardly along the z-axis.

The inserts 240 may be made of or include tungsten carbide. The inserts 240 may be made of or include a material similar to or identical to the material of the petals 230. Such materials may be harder than the material of the body 220. Each insert 240 may be located between two petals 230. The insert 240 may have a forward surface 241, a rearward surface (not visible in the figures), and a side 242. The insert 240 may be coupled (e.g., brazed, soldered, or otherwise fixed in relation) to the body 220 and/or one or more of the petals 230. For example, a portion of the circumferential surface of the insert 240 (the thinner surface that forms a band around the insert 240, not all of which is visible) and/or the side 242 may be brazed (or otherwise coupled) to the forward surface 221 and/or side 223 of the body 220. As another example, portions of the circumferential surface of the insert 240 and/or the side 242 may be brazed (or otherwise coupled) to the sides 232 and/or the surfaces of the neighboring petals 230 that face the insert 240 (not visible in the figures).

Each insert 240 is positioned next to a corresponding side 223 of the body 220. The side 242 of the insert 240 may extend outwardly beyond the corresponding side 223 of the body 220. The side 242 of the insert 240 may also extend outwardly beyond the sides 232 of the two neighboring petals 230. The portion of the insert 240 that extends outwardly beyond the corresponding side 223 of the body 220 and the corresponding sides 232 of the neighboring petals 230 forms a lip 244. The lip 244 may have a constant thickness or a varying thickness. In one example, the lip 244 has a substantially constant thickness, and may be approximately 1 mm thick, although greater or lesser thicknesses (varying or constant) are also considered.

The forward surface 241 of the insert 240 may include a first face 245 and a second face 246. A cutting edge 247 extends along the outer edges of both faces 245, 246. The faces 245, 246 may be substantially flat, and may slope downwardly towards a central location on the forward surface 241 of the insert 240. This central location may be a location of minimum elevation (minimum) on the forward surface of the tooth 200 (as measured along the z-axis shown in FIG. 3A). Each of the faces 245, 246 may be coplanar with the respective forward surfaces 231 of the respective neighboring petals 230. Each of the faces 245, 246 may form a continuous surface with the respective forward surfaces 231 of the respective neighboring petals 230.

The configuration of the insert 240, the two neighboring petals 230, and the body 220 may form different joints. A first joint is located between the insert 240 and a first one of the neighboring petals 230. The first joint includes a forward extent 202 (shown more clearly in FIG. 3C) and a sideward extent 203 (shown more clearly in FIG. 3B). A second joint is located between the insert 240 and a second one of the neighboring petals 230. The second joint includes a forward extent 205 (shown more clearly in FIG. 3C) and a sideward extent 206 (shown more clearly in FIG. 3B). A third joint is formed between the insert 240 and the body 220. As shown more clearly in FIG. 3B, the third joint includes a first segment 208 and a second segment 209.

The first joint (which may include forward and sideward extents 202, 203) may be angled along one, two, or all three of the x-, y-, and z-axes. The second joint (which may include forward and sideward extents 205, 206) may also be angled along one, two, or all three of the x-, y-, and z-axes. As shown, each of the first joint and second joint are angled along all three of the Cartesian axes.

As shown more clearly in FIG. 3C, the forward extent 202 of the first joint and the forward extent 205 of the second joint may converge towards each other as they approach an outer perimeter of the forward surface of the tooth 200. As shown more clearly in FIG. 3B, the sideward extent 203 of the first joint and the sideward extent 206 of the second joint may diverge away from each other as they extend downwardly along the z-axis. The first segment 208 and second segment 209 of the third joint may be parallel to each other.

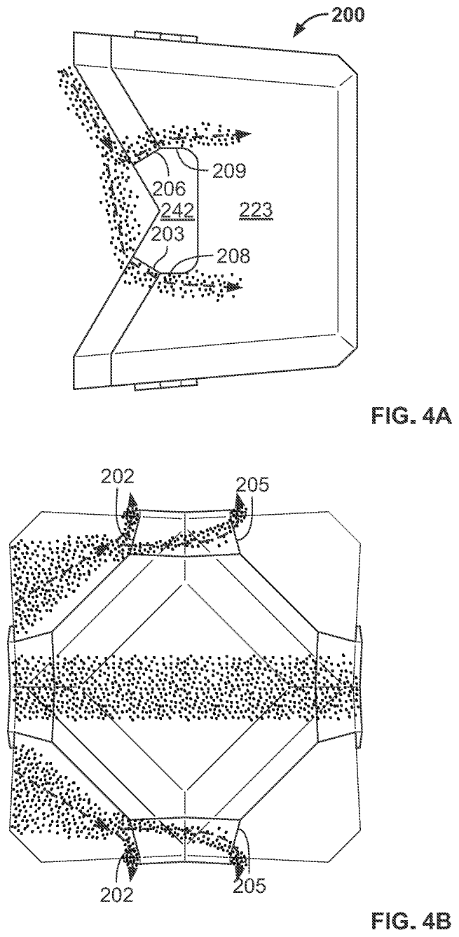

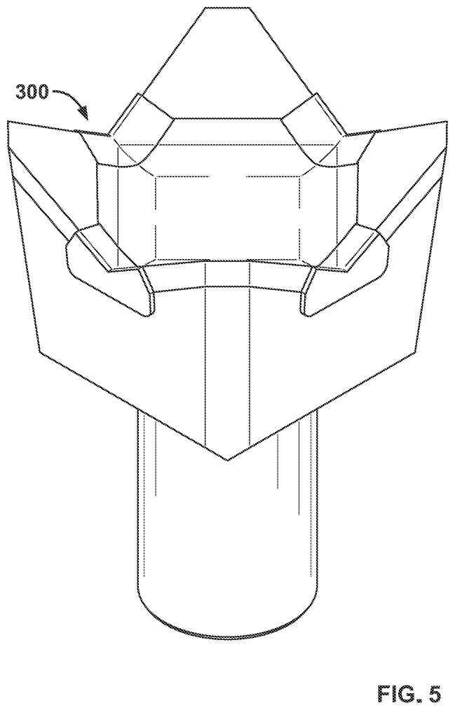

FIGS. 4A and 4B show an elevation view and a top plan view, respectively, of the tooth 200 illustrated in FIG. 3A. FIGS. 4A and 4B further depict debris flows across the tooth 200 generated by the cutting process. Tooth 200 may be in many ways similar to tooth 10, in that it attaches to a tooth holder 110, which in turn is attached to the disk 120. Therefore, the remainder of the saw 100 (tooth holder 110 and disk 120) and tree trunk are not reproduced. Instead, FIGS. 4A and 4B only show the tooth 200 and the debris flows that are generated by the cutting process. FIG. 4A shows the tooth 200 in the same orientation as tooth 10 in FIG. 2A. FIG. 4B shows the tooth 200 in approximately the same orientation as tooth 10 in FIG. 2B, except that FIG. 4B only shows the forward surface of the tooth 200 whereas FIG. 2B shows sides of tooth 10 as well.

For at least the following reasons, and as will be further described in more detail, tooth 200 may have improved resistance to wear caused by debris flows as compared to tooth 10. For example, in tooth 200, the first and third debris flows may tend not to concentrate at the corresponding minimums. Additionally, there may be no joints at the minimums.

Furthermore, a given debris flow may separate into two lesser flows that tend to flow around the insert 240. These lesser debris flows then may not extend straight across the sides of the tooth 200. Instead, the lesser debris flows may diverge away from each other because of the shape of the insert 240, thereby fanning out the overall flow of debris more diffusely. Moreover, the orientation of the joints 202, 205 on the forward surface of the tooth 200 may not align with the debris flows.

FIG. 4B depicts three debris flows, each of which start at or near the cutting edges 234 and 247 on the tooth 200 (labeled in FIG. 3C). These three debris flows are similar to the ones shown in FIG. 2B, and will be referred to with the same conventions: the first debris flow is on top; the second debris flow is in the middle; and the third debris flow is on the bottom. The first debris flow may be generated by debris from wood cut at least partially by a portion of the cutting edge 234 of the upper-right petal 230 and advances towards the upper insert 240. The second debris flow may be generated by debris from wood cut at least partially by the cutting edge 247 of the right-side insert 240 and advances towards the left-side insert 240. The third debris flow may be generated by debris from wood cut at least partially by a portion of the cutting edge 234 of the lower-right petal 230 and advances towards the lower insert 240.

FIG. 4A depicts a different view of the third debris flow. The second debris flow has been omitted, but it should be understood that it could be represented in a similar manner to the second debris flow described with respect to FIG. 2A. The first debris flow cannot be seen from the perspective of FIG. 4A, because the elevation view obscures the opposite side of the tooth 200. Therefore, the discussion below will proceed with respect to the third debris flow, since it is illustrated in both FIGS. 4A and 4B.

As shown in FIG. 4B, the third debris flow may advance across the forward surface of the tooth 200 in a direction generally towards the lower insert 240. However, because the side 242 of the insert 240 extends beyond the neighboring sides 232 of the neighboring petals 230 and extends beyond the neighboring side 223 of the body 220, the third debris flow may tend to be inhibited from flowing through the minimum at the upper insert 240. Instead, the third debris flow separates into two lesser debris flows that may tend to be concentrated along paths that extend around the upper insert 240. Additionally, neither of the forward extents 202, 205 of the first and second joints 201, 204, respectively, may align with the lesser debris flows. Because the flow debris flow may decompose into two lesser debris flows, and neither of the lesser debris flows may align with a joint located on the forward surface of the tooth 200, the degree of wear on the forward surface of the tooth 200 is reduced.

As shown in FIG. 4A, the third debris flow may divide into two lesser debris flows, each of which may proceed down the side of the tooth 200 (e.g., over the sides 232 of the neighboring petals 230 and the side 223 of the body 220).

Because of the symmetric nature of the tooth 200, the first debris flow may tend to behave in a manner similar to the third debris flow. Therefore, the description above will not be repeated with respect to the first debris flow.

FIG. 5 shows a tooth 300, which may be like tooth 200 except that tooth 300 includes a shaft and does not have a hole that extends to the forward surface of the tooth 300. Instead, with tooth 300, the hole that accepts the mounting bolt (not shown) may extend through at least a portion of the shaft but may stop short of the forward surface of the tooth 300.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A saw tooth, comprising:
a body including a first material, wherein the body has a forward surface defining a perimeter, a rearward surface, a plurality of sides extending between the forward and rearward surfaces, and a plurality of corners located between the sides;
a plurality of petals, wherein for each of the petals, the petal includes a second material, the petal includes a forward surface and a rearward surface, the rearward surface defines a perimeter, the petal is coupled to the forward surface of the body, and the perimeter of the rearward surface of the petal does not extend outwardly beyond the perimeter of the forward surface of the body; and
a plurality of inserts, wherein for each of the inserts, the insert includes the second material, the insert has an outer side, the insert is positioned between two of the petals, the insert is coupled to at least one of the body or one petal or two petals, and the outer side extends outwardly beyond a corresponding side of the body.

2. The saw tooth of claim 1, wherein for each of at least one of the plurality of inserts, the insert is configured to cause a flow of debris across a forward surface of the saw tooth to divide into plurality of lesser flows of debris.

3. The saw tooth of claim 1, wherein the second material is harder than the first material.

4. The saw tooth of claim 3, wherein the second material comprises carbide.

5. The saw tooth of claim 4, wherein the first material comprises steel.

6. The saw tooth of claim 1, wherein for each of the inserts, a first joint is located between the insert and one of the petals, and a second joint is located between the insert and a different one of the petals, wherein each of the first and second joints define a forward extent and a sideward extent, and wherein the forward extent of the first joint and the forward extent of the second joint converge as the forward extents approach an outer perimeter of the forward surface of the saw tooth.

7. The saw tooth of claim 6, wherein for each of the inserts, the sideward extent of the first joint and the sideward extent of the second joint diverge as the sideward extents extend downwardly from the outer perimeter of the forward surface of the saw tooth.

8. The saw tooth of claim 7, wherein for each of the inserts, the insert is configured to cause a flow of debris across a forward surface of the saw tooth to divide into plurality of lesser flows of debris.

9. The saw tooth of claim 8, wherein at least two of the plurality of lesser flows of debris flow in diverging directions across at least a portion of a side of the saw tooth.

10. The saw tooth of claim 6, wherein for each of the inserts, the sideward extent of the first joint and the sideward extent of the second joint diverge as the joints extend downwardly from the outer perimeter of the forward surface of the saw tooth.

11. The saw tooth of claim 10, wherein for each of the inserts, a third joint is located between the insert and the body, and wherein two segments of the third joint are parallel to each other.

12. The saw tooth of claim 11, wherein at least a portion of the first joints, the second joints, or the third joints include a third material.

13. The saw tooth of claim 10, wherein at least a portion of the first joints, the second joints, or the third joints is not comprised of a material.

14. The saw tooth of claim 1, wherein for each of the inserts, a first joint is located between the insert and one of the petals, and a second joint is located between the insert and a different one of the petals, wherein each of the first and second joints define a forward extent and a sideward extent, and wherein the sideward extent of the first joint and the sideward extent of the second joint diverge as the sideward extents extend downwardly from an outer perimeter of the forward surface of the saw tooth.

15. The saw tooth of claim 14, wherein for each of the inserts, the insert is configured to cause a flow of debris across a forward surface of the saw tooth to divide into plurality of lesser flows of debris.

16. The saw tooth of claim 15, wherein at least two of the plurality of lesser flows of debris flow in diverging directions across a side of the saw tooth.

17. The saw tooth of claim 1, wherein for each of the petals, the petal includes a corner that corresponds to one of the corners of the body, and the corner of the petal and each of the corners of the body are chamfered.

18. The saw tooth of claim 1, wherein for each of the inserts, the insert has a forward surface with a left portion and a right portion, wherein the left portion is coplanar with the forward surface of one of the petals, and wherein the right portion is coplanar with the forward surface of another of the petals.

19. The saw tooth of claim 1, wherein for each of the petals, a thickness between the forward surface and the rearward surface varies.

20. The saw tooth of claim 19, wherein for each of the petals, the petal includes a corner that corresponds to one of the corners of the body, and the thickness between the forward surface and the rearward surface is greatest at the corner.
